(19) United States
(12) Patent Application Publication
(10) Pub. No.: US 2016/0035276 A1
(43) Pub. Date: Feb. 4, 2016

(54) OLED PIXEL CIRCUIT, DRIVING METHOD OF THE SAME, AND DISPLAY DEVICE

(71) Applicant: BOE TECHNOLOGY GROUP CO., LTD., Beijing (CN)

(72) Inventors: Jingwen YIN, Beijing (CN); Zhongyuan WU, Beijing (CN)

(21) Appl. No.: 14/422,822

(22) PCT Filed: Apr. 25, 2014
(86) PCT No.: PCT/CN2014/076242

§ 371 Date: Feb. 20, 2015

(30) Foreign Application Priority Data
Dec. 12, 2013 (CN) 201310683541.4

(51) Int. Cl. G09G 3/32; G09G 3/20

(52) U.S. Cl. CPC G09G 3/3225; G09G 3/2092; G09G 2300/0426

(57) ABSTRACT

An OLED pixel circuit includes a data storage and threshold compensation module, a switch module, a driving module, and a light-emitting module. The data storage and threshold compensation module is connected to the driving module, the switch module, a scanning signal line, and a data signal line, respectively, and is used for inputting a data signal on the data signal line to the driving module and compensating a threshold voltage of the driving module according to a scanning signal of the scanning signal line. The switch module is connected to the driving module, the light-emitting module, and a light emission control signal line, respectively, and is used for inputting the data signal provided by the threshold-compensated driving module to the light-emitting module according to a control signal of the light emission control signal line, so that the light-emitting module is driven to emit light.

### FIELD OF THE INVENTION

The present invention relates to the field of display technology, and in particular, relates to an OLED pixel circuit, a driving method of the same, and a display device.

### BACKGROUND OF THE INVENTION

Along with rapid advancement in multimedia technology, technologies of semiconductor component and display device also have a leap of progress. As for display devices, an OLED (organic light-emitting diode) has become an important light-emitting element in a newly developed flat panel display device due to its advantages of self-luminescence, high contrast, wide color gamut, simple manufacturing process, low power consumption, being easy to implement flexible display ant the like.

In particular, an active matrix organic light-emitting diode (AMOLED) display device, due to its advantages of unlimited viewing angle, low manufacturing cost, high response speed (which is about one hundred times that of a liquid crystal display device or higher), power saving, large range of operating temperature, light weight, direct current drive applicable to portable equipment, capability of being miniaturized and thinned down along with a hardware equipment, and the like, has great potential for development, is expected to be the next generation of new flat panel display device, and has trend of substituting a liquid crystal display to a great extent.

In a pixel structure of an AMOLED display panel, a set comprising a thin film transistor (TFT) and a storing capacitor (C_{S}) is integrated in each sub-pixel. An electric current passing through the OLED in a sub-pixel is controlled to enable the OLED to emit light by controlling the drive of the thin film transistors TFT and the storing capacitor C_{S}. At present, there are mainly three methods for manufacturing the thin film transistor in the AMOLED display panel, specifically, in a first method, i an amorphous silicon (α-Si) process is adopted, in a second method, a low temperature poly-silicon (LTPS) process is adopted, and in a third method, an oxide process is adopted. Generally, the thin film transistor may be a P-type or an N-type.

However, an electric current passing through the OLED is not only controlled by a data voltage V_{DATA} but also affected by a threshold voltage V_{TH} of the TFT, no matter whether a P-type TFT or a N-type TFT is selected to implement the organic light-emitting diode pixel circuit. Since characteristics such as threshold voltages, mobility ratios and the like of the TFTs in the plurality of pixel circuits differs, the TFTs in the pixel circuits are unlikely to have completely consistent performance parameters. At the same time, with increased time of voltage stress, a threshold voltage of a TFT may shift. As a result, the electric current passing through the OLED changes not only with a change in a turned-on voltage (V_{OLED}_{_{—}}_{TH}) of the OLED due to long time stress, but also with a shift of the threshold voltage V_{TH} of the thin film transistor TFT for driving the OLED. Thus, electric currents passing through the OLEDs in respective OLED pixel circuits are different from each other, which leads to uniform brightness in the OLED pixel circuits, and further affects brightness uniformity and brightness constancy of an organic light-emitting diode display device. Hence, the display effect of the organic light-emitting diode display device is affected. Further, in a current organic light-emitting diode display device, since an OLED is in a positive bias state for a long time, resulting in a short service life of the OLED. Thus, a service life of the organic light-emitting diode display device is affected.

### SUMMARY OF THE INVENTION

In view of the above problems existing in the prior art, the technical problem to be solved by the present invention is to provide an OLED pixel circuit, a driving method of the same, and a display device. The OLED pixel circuit can compensate a threshold voltage effectively, so that brightness uniformity of light emitted from respective OLED pixel circuits is ensured, and a service life of an organic light-emitting diode can be extended.

A technical solution employed to solve the technical problem of the present invention is an OLED pixel circuit including a data storage and threshold compensation module, a switch module, a driving module, and a light-emitting module, wherein

the data storage and threshold compensation module is connected to the driving module, the switch module, a scanning signal line, and a data signal line, respectively, and is used for inputting a data signal on the data signal line to the driving module and compensating a threshold voltage of the driving module according to a scanning signal of the scanning signal line; and

the switch module is connected to the driving module, the light-emitting module, and a light emission control signal line, respectively, and is used for inputting a data signal provided by the threshold-compensated driving module to the light-emitting module according to a control signal of the light emission control signal line, so as to drive the light-emitting module to emit light.

Preferably, the driving module includes a control terminal, an input terminal, and an output terminal, wherein

the control terminal of the driving module is connected to the data storage and threshold compensation module, the input terminal of the driving module is connected to the switch module and a first voltage terminal, which is a variable voltage supply terminal, and the output terminal of the driving module is connected to the data storage and threshold compensation module and the switch module.

Preferably, the light-emitting module is further connected to a second voltage terminal, which is a low-voltage supply terminal.

Preferably, the driving module includes a first transistor, the control terminal of the driving module is a gate of the first transistor, the input terminal of the driving module is a first electrode of the first transistor, and the output terminal of the driving module is a second electrode of the first transistor.

Preferably, the data storage and threshold compensation module includes a second transistor, a third transistor, and a storing capacitor, wherein

a gate of the third transistor is connected to the scanning signal line, a first electrode of the third transistor is connected to the data signal line, and a second electrode of the third transistor is connected to one terminal of the storing capacitor; and

a gate of the second transistor is connected to the scanning signal line, a first electrode of the second transistor is connected to the gate of the first transistor and the other terminal of the storing capacitor, and a second electrode of the second transistor is connected to the second electrode of the first transistor.

Preferably, the switch module includes a fourth transistor and a fifth transistor, wherein

a gate of the fourth transistor is connected to the light emission control signal line, a first electrode of the fourth transistor is connected to the first electrode of the first transistor, and a second electrode of the fourth transistor is connected to the second electrode of the third transistor and the one terminal of the storing capacitor; and

a gate of the fifth transistor is connected to the light emission control signal line, a first electrode of the fifth transistor is connected to the second electrode of the first transistor, and a second electrode of the fifth transistor is connected to the light-emitting module.

Preferably, the first to fifth transistors in the OLED pixel circuit are all N-type transistors, all P-type transistors, or a collection of N-type transistors and P-type transistors.

Preferably, the light-emitting module includes an OLED, an anode of the OLED is connected to the second electrode of the fifth transistor, and a cathode of the OLED is connected to the second voltage terminal.

The present invention further provides a display device including the OLED pixel circuit as described above.

The present invention further provides a driving method of the above OLED pixel circuit, and the driving method includes steps of:

in a data storage and threshold compensation stage, inputting a scanning signal and a data signal, so that the data storage and threshold compensation module is turned on, and the data storage and threshold compensation module stores a data voltage and compensates a threshold voltage of the driving module; and

in a light-emitting stage, inputting a light emission control signal, so that the switch module is turned on, and the driving module drives the light-emitting module to emit light.

Preferably, the driving method specifically includes steps of:

in the data storage and threshold compensation stage, inputting the scanning signal through the scanning signal line, and inputting the data signal through the data signal line, so that a low level of the first voltage terminal is input to the first electrode of the first transistor, the second and third transistors are turned on, the fourth and fifth transistors are turned off, and the storing capacitor stores the data voltage and a threshold voltage of the first transistor; and

in the light-emitting stage, inputting the light emission control signal through the light emission control signal line, so that the second and third transistors are turned off, the fourth and fifth transistors are turned on, a high level of the first voltage terminal is input to the first electrode of the first transistor, and the second electrode of the first transistor drives the light-emitting module to emit light, so as to achieve display.

Preferably, the low level of the first voltage terminal ranges from 1 V to 3 V, and the high level of the first voltage terminal ranges from 10 V to 15 V.

The advantageous effects of the present invention are as follows. An OLED pixel circuit is provided, the OLED pixel circuit can compensate a threshold voltage of a driving transistor therein, and output a data signal which has subjected to the threshold voltage compensation, so as to compensate a shift of the threshold voltage of the driving transistor. Thus, a drive current is not affected by the threshold voltage of the driving transistor, and the display effect of an OLED display device is improved. Further, since an OLED in the OLED pixel circuit is in a positive bias state only in a light-emitting stage, a service life of the OLED can be extended; at the same time, the OLED pixel circuit has high reliability due to its simple structure.

### BRIEF DESCRIPTION OF THE DRAWINGS

FIG. 1 is a block diagram showing a structure of an OLED pixel circuit according to Embodiment 1 of the present invention;

FIG. 2 is a schematic diagram showing a structure of the OLED pixel circuit according to Embodiment 1 of the present invention;

FIG. 3 is a signal timing diagram corresponding to the OLED pixel circuit shown in FIG. 2;

FIG. 4 is a schematic diagram of a structure corresponding to the OLED pixel circuit of FIG. 2 in a data storage and threshold compensation stage; and

FIG. 5 is a schematic diagram of a structure corresponding to the OLED pixel circuit of FIG. 2 in a light-emitting stage.

### REFERENCE NUMERALS

1—data storage and threshold compensation module;
2—switch module;
3—driving module; and
4—light-emitting module.

### DETAILED DESCRIPTION OF THE EMBODIMENTS

For better understanding the technical solutions of the present invention by a person skilled in the art, an OLED pixel circuit, a driving method of the same, and a display device according to the present invention will be further described in detail below with reference to the accompanying drawings and specific embodiments.

An OLED pixel circuit includes a data storage and threshold compensation module, a switch module, a driving module, and a light-emitting module, wherein

the data storage and threshold compensation module is connected to the driving module, the switch module, a scanning signal line, and a data signal line, respectively, and is used for inputting a data signal on the data signal line to the driving module and compensating a threshold voltage of the driving module according to a scanning signal of the scanning signal line; and

the switch module is connected to the driving module, the light-emitting module, and a light emission control signal line, respectively, and is used for inputting a data signal provided by the threshold-compensated driving module to the light-emitting module according to a control signal of the light emission control signal line, so as to drive the light-emitting module to emit light.

A display device includes the OLED pixel circuit as described above.

A driving method of an OLED pixel circuit, the OLED pixel circuit includes: a data storage and threshold compensation module, a switch module, a driving module, and a light-emitting module, and the driving method includes the following steps:

in a data storage and threshold compensation stage, inputting a scanning signal and a data signal, so that the data storage and threshold compensation module is turned on, and the data storage and threshold compensation module stores a data voltage and compensates a threshold voltage of the driving module; and

in a light-emitting stage, inputting a light emission control signal, so that the switch module is turned on, and the driving module drives the light-emitting module to emit light.

### Embodiment 1

The present embodiment provides an OLED pixel circuit and a driving method of the same.

There is provided an OLED pixel circuit, of which each sub-pixel is connected to a scanning signal line SCAN, a data signal line DATA, a variable voltage supply terminal V_{DD}, a common light emission control signal line EM, and a grounding voltage terminal V_{SS}. The structure of this OLED pixel circuit is a structure of 5T1C (i.e., five transistors and one storing capacitor). The storing capacitor mainly serves to store a data voltage V_{DATA} and a threshold voltage V_{TH} of a driving transistor.

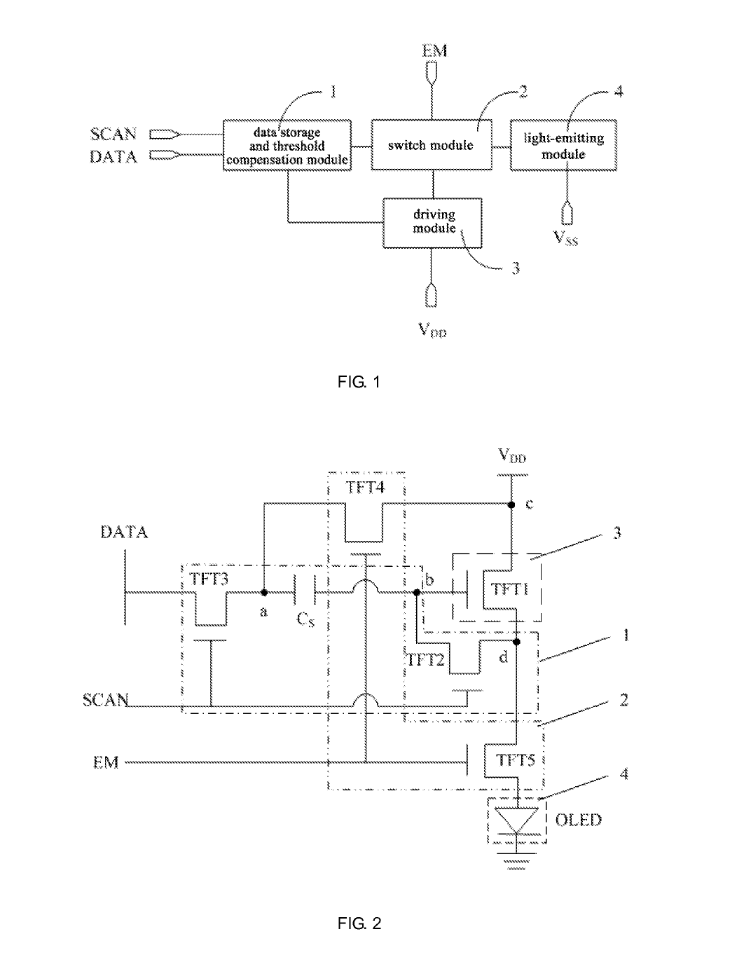

As shown in FIG. 1, the OLED pixel circuit in the present embodiment includes a data storage and threshold compensation module 1, a switch module 2, a driving module 3, and a light-emitting module 4. The data storage and threshold compensation module 1 is connected to the driving module 3, the switch module 2, a scanning signal line SCAN, and a data signal line DATA, respectively, and is used for inputting a data signal (i.e., a data voltage V_{DATA}) on the data signal line DATA to the driving module 3 and compensating a threshold voltage V_{TH} of a driving transistor of the driving module 3 according to a scanning signal Sn of the scanning signal line SCAN.

The switch module 2 is further connected to the driving module 3, the light-emitting module 4, and a light emission control signal line EM, respectively, and is used for inputting a data signal provided by the driving module 3 which has been threshold-compensated to the light-emitting module 4 according to a control signal Em of the light emission control signal line EM, so as to drive the light-emitting module 4 to emit light.

The driving module 3 includes a control terminal, an input terminal and an output terminal. The control terminal of the driving module 3 is connected to the data storage and threshold compensation module 1; the input terminal of the driving module 3 is connected to the switch module 2 and a first voltage terminal V_{DD}, which is a variable voltage supply terminal; the output terminal of the driving module 3 is connected to the data storage and threshold compensation module 1 and the switch module 2.

Specifically, as shown in FIG. 2, the driving module 3 includes a first transistor TFT1. The control terminal of the driving module 3 is a gate of the first transistor TFT1, the input terminal of the driving module 3 is a first electrode of the first transistor TFT1, and the output terminal of the driving module 3 is a second electrode of the first transistor TFT1.

The data storage and threshold compensation module includes a second transistor TFT2, a third transistor TFT3, and a storing capacitor C_{S}. A gate of the third transistor TFT3 is connected to the scanning signal line SCAN, a first electrode of the third transistor TFT3 is connected to the data signal line DATA, and a second electrode of the third transistor TFT3 is connected to one terminal of the storing capacitor C_{S}.

A gate of the second transistor TFT2 is connected to the scanning signal line SCAN, a first electrode of the second transistor TFT2 is connected to the gate of the first transistor TFT1 and the other terminal of the storing capacitor C_{S}, and a second electrode of the second transistor TFT2 is connected to the second electrode of the first transistor TFT1.

The switch module 2 includes a fourth transistor TFT4 and a fifth transistor TFT5.

A gate of the fourth transistor TFT4 is connected to the light emission control signal line EM, a first electrode of the fourth transistor TFT4 is connected to the first electrode of the first transistor TFT1, and a second electrode of the fourth transistor TFT4 is connected to the second electrode of the third transistor TFT3 and said one terminal of the storing capacitor C_{S}.

A gate of the fifth transistor TFT5 is connected to the light emission control signal line EM, a first electrode of the fifth transistor TFT5 is connected to the second electrode of the first transistor TFT1, and a second electrode of the fifth transistor TFT5 is connected to the light-emitting module 4.

The light-emitting module 4 includes an OLED. An anode of the OLED is connected to the second electrode of the fifth transistor TFT5, of which the first electrode is connected to the output terminal of the driving module 3, and a cathode of the OLED is connected to the second voltage terminal V_{SS}, which is a low voltage supply terminal.

Here, it should be noted that, in FIG. 2, the control terminal of the driving module 3 is a node b, which is a connection point of the data storage and threshold compensation module 1 and the driving module 3. The input terminal of the driving module 3 is a node c, which is a connection point of the switch module 2 and the driving module 3. The output terminal of the driving module 3 is a node d, which is a connection point of the driving module 3, the switch module 2 and the light-emitting module 4. As for the storing capacitor C_{S}, the one terminal of the storing capacitor C_{S} is a connection point (i.e., a node a) of the data storage and threshold compensation module 1 and the switch module 2, i.e., a connection point of the second electrode of the third transistor TFT3, the second electrode of the fourth transistor TFT4 and the one terminal of the storing capacitor C_{S}. The other terminal of the storing capacitor C_{S} is the control terminal of the driving module 3 (i.e., the node b).

In the present embodiment, the first transistor TFT1 is a driving transistor, the second transistor TFT2 is a threshold voltage acquisition transistor for acquiring a threshold voltage of the driving transistor, the third transistor TFT3 is a writing transistor for writing a data signal, and the fourth transistor TFT4 and the fifth transistor TFT5 are switch control transistors for the light-emitting module. The first voltage terminal V_{DD} provides a power signal, and the second voltage terminal V_{SS} provides a grounding signal. The second electrode of the writing transistor, the one terminal of the storing capacitor C_{S}, and the second electrode of one switch control transistor are connected at the node a, and the first electrode of the writing transistor is connected to the data signal line DATA. The gate of the driving transistor, the first electrode of the threshold voltage acquisition transistor, and the other terminal of the storing capacitor C_{S} are connected at the node b. Both the gate of the threshold voltage acquisition transistor and the gate of the writing transistor are controlled by the scanning signal line SCAN, which provides a row strobe signal Sn, and the data voltage V_{DATA} charges the storing capacitor C_{S} via the writing transistor, to provide a data signal with display information to the strobed OLED. The first electrode of the driving transistor and the first electrode of the one switch control transistor are connected at the node c, which is further connected to the variable voltage supply terminal V_{DD}. The second electrode of the driving transistor, the second electrode of the threshold voltage acquisition transistor, and the first electrode of the other switch control transistor are connected at the node d. The second electrode of the other switch control transistor is connected to the anode of the OLED, and the cathode of the OLED is connected to the second voltage terminal (i.e., a common grounding terminal). The gates of the two switch control transistors are controlled by the light emission control signal line EM, so that a data signal can control an electric current flowing through an OLED, which enable the OLED to emit light and achieve display.

In the present embodiment, the transistors in the OLED pixel circuit are described by taking thin film transistors (TFTs) as an example. Specifically, all of the first to fifth transistors TFT1 to TFT5 in the OLED pixel circuit may be N-type transistors. In this case, the first electrode may be a source, and the second electrode may a drain. Alternatively, all of the TFT1 to the TFT5 in the OLED pixel circuit may be P-type transistors. In this case, the first electrode may be a drain, and the second electrode may a source. Alternatively, some of the TFT1 to the TFT5 in the OLED pixel circuit may be N-type transistors and the others may be P-type transistors, as long as polarities of terminals of the transistors TFT1 to TFT5 of the selected types are correspondingly connected according to the above-described polarities of terminals of the transistors TFT1 to TFT5 of the present embodiment. At the same time, it should be understood that, the TFT1 to the TFT5 in the present embodiment are not limited to thin film transistors, and any control device having voltage control capability to make the present invention operate in the above operating mode should fall within the protection scope of the present invention. A person skilled in the art can make a change according to practical requirements, and detailed description thereof is omitted herein.

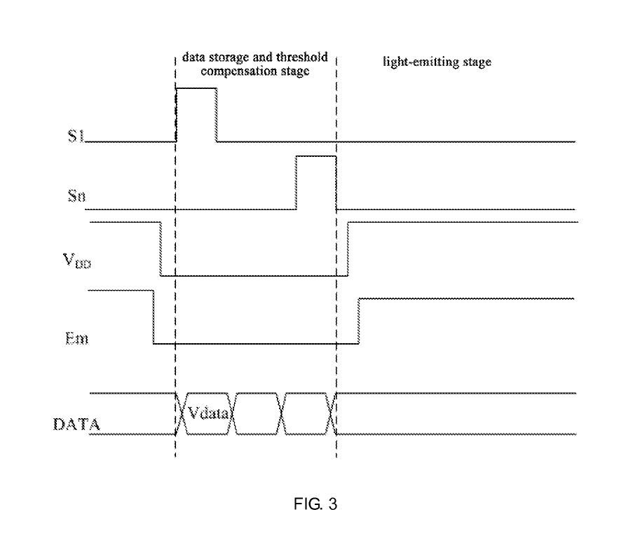

FIG. 3 is a signal timing diagram of the OLED pixel circuit in the present embodiment. A driving process of the OLED pixel circuit in the present embodiment mainly includes a data storage and threshold compensation stage and a light-emitting stage. The first voltage terminal V_{DD} may provide a variable voltage. When the first voltage terminal V_{DD} provides a reference voltage to the gate of the second transistor TFT2, the V_{DD} has a voltage ranging from 1 V to 3 V, and when the first voltage terminal V_{DD} provides, to the OLED, a power signal voltage for driving, the V_{DD} has a voltage ranging from 10 V to 15 V. A range of the data voltage V_{DATA} is set according to driving requirements of the OLED pixel circuit in a specific application.

Correspondingly, a driving method of the OLED pixel circuit in the present embodiment includes steps of:

in a data storage and threshold compensation stage, inputting a scanning signal and a data signal, so that the data storage and threshold compensation module is turned on, and the data storage and threshold compensation module stores a data voltage and compensates a threshold voltage of the driving module; and

in a light-emitting stage, inputting a light emission control signal, so that the switch module is turned on, and the driving module drives the light-emitting module to emit light.

Specifically, the driving method of the OLED pixel circuit in the present embodiment includes steps as follows.

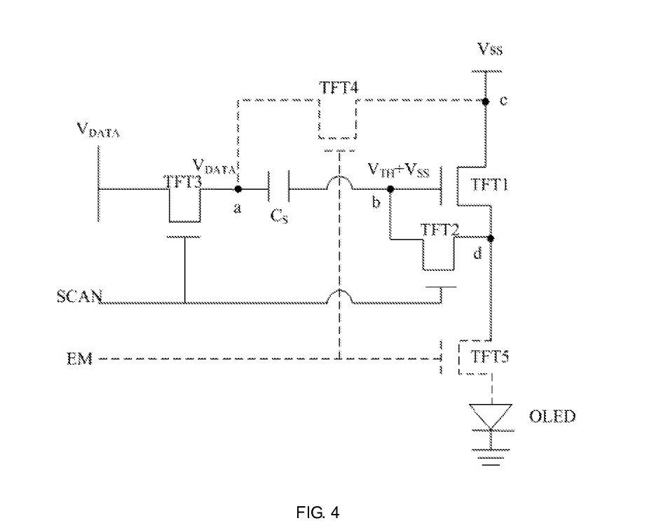

in the data storage and threshold compensation stage, as shown in FIG. 4, the scanning signal lines SCAN are enabled row by row, and input scanning signals S1, . . . , Sn row by row therethrough, the third transistor TFT3 and the second transistor TFT2 are turned on; the data signals are input through the data signal lines DATA, and the data signals provide required data voltage V_{DATA} to each row of OLED pixel circuits as the scanning signal lines SCAN are enabled; the light emission control signal line EM is at a low level, and the fourth transistor TFT4 and the fifth transistor TFT5 are turned off.

Since the one terminal of the storing capacitor C_{S} is connected to the second electrode of the third transistor TFT3, the data voltage V_{DATA} can be stored at the node a, and at this point, a voltage of the storing capacitor C_{S} at the node a is the data voltage V_{DATA}. The other terminal of the storing capacitor C_{S} is connected to the gate of the first transistor TFT1 and the first electrode of the second transistor TFT2, And since the second transistor TFT2 is turned on, which is equivalent to that the gate of the first transistor TFT1 is directly connected to the second electrode thereof at this time, the first voltage terminal V_{DD} is at a low level, and outputs a low voltage V_{SS}, which is input to the first electrode of the first transistor TFT1. The storing capacitor C_{S} discharges via the first transistor TFT1 in a manner of being connected to a diode, until the first transistor TFT1 is turned off, at this time, a voltage of the storing capacitor C_{S} at the node b has a value of V_{SS}+V_{TH}. Thus, the storage of the data voltage V_{DATA} and the acquisition of the threshold voltage V_{TH} of the driving transistor are achieved at the same time (i.e., the storing capacitor C_{S} stores the data voltage V_{DATA} and the threshold voltage V_{TH} of the first transistor TFT1), and a difference in voltage between the node a and the node b includes the threshold voltage V_{TH} and the data voltage V_{DATA}.

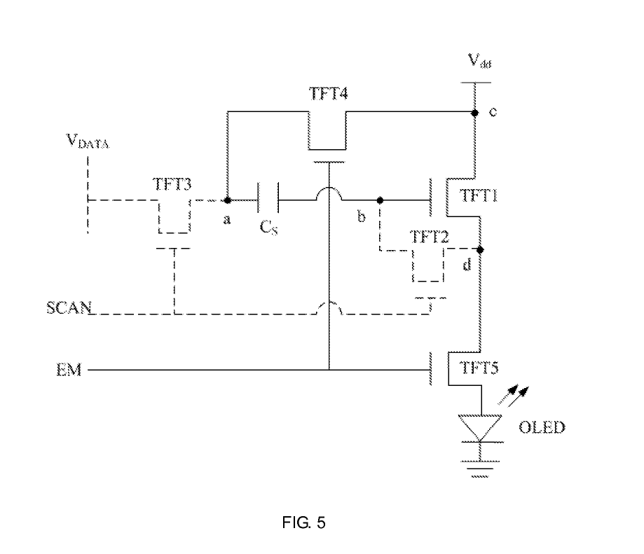

In the light-emitting stage, as shown in FIG. 5, the light emission control signal line is enabled, inputs the light emission control signal Em therethrough, and the third transistor TFT3 and the second transistor TFT2 are turned off. The light emission control signal line EM is at a high potential, the fourth transistor TFT4 and the fifth transistor TFT5 are turned on, the first voltage terminal V_{DD} is at a high level and outputs a high voltage V_{dd}, which is input to the first electrode of the first transistor TFT1, and the second electrode of the first transistor TFT1 drives the light-emitting module 4 to emit light, thereby achieving display.

Since the one terminal of the storing capacitor C_{S} is connected to the second electrode of the fourth transistor TFT4, a voltage of the storing capacitor C_{S} at the node a is pulled up to the voltage V_{dd} because the fourth transistor TFT4 is turned on. At this time, a voltage at the other terminal of the storing capacitor C_{S} increases due to the voltage-boosting effect of the capacitor. Thus, a voltage at the node b has a value of V_{dd}−V_{DATA}+V_{TH}+V_{SS}, while a voltage at the second electrode of the first transistor TFT1 has a value of V_{OLED}+V_{SS}, wherein V_{OLED} is a voltage across the two ends of the OLED. At this time, a voltage between the gate and the second electrode of the first transistor TFT1 is expressed as follows: V_{GS}=V_{dd}−V_{DATA}+V_{TH}+V_{SS}−V_{OLED}−V_{SS}=V_{dd}−V_{DATA}+V_{TH}−V_{OLED}. Thus, in the light-emitting stage, a drive current I_{OLED} generated by the first transistor TFT1 may be expressed by the following equation:

$$\begin{matrix}{I}_{OLED} = \frac{1}{2} K \times {( {V}_{GS} - {V}_{TH} )}^{2} \\ = \frac{1}{2} K \times {( {V}_{dd} - {V}_{DATA} + {V}_{TH} - {V}_{OLED} - {V}_{TH} )}^{2} \\ = \frac{1}{2} K \times {( {V}_{dd} - {V}_{DATA} - {V}_{OLED} )}^{2}\end{matrix} \qquad ( 1 )$$

In the equation (1), K is a current constant related to the characteristics of the first transistor TFT1 (the driving transistor), V_{dd} is the power signal voltage provided by the first voltage terminal V_{DD}, V_{DATA} is the written data voltage, and V_{OLED} tends to be a constant after being in use for a long time.

It can be seen from the equation (1) that, in the light-emitting stage, the drive current I_{OLED} flowing through the OLED is irrelative with the threshold voltage V_{TH} of the first transistor TFT1. Therefore, since V_{dd} is a given voltage value after the first transistor TFT1 is given, a value of the electric current flowing through the OLED is only affected by the data voltage V_{DATA} and a capacitance of the storing capacitor C_{S}, and is independent of the threshold voltage of the driving transistor in the pixel circuit. That is, even if the threshold voltage V_{TH} of the driving transistor differs or shifts, the electric current flowing through the OLED will not be affected. Therefore, an influence of the threshold voltage V_{TH} on the electric current flowing through the OLED is eliminated, i.e., the problem that the threshold voltage of the driving transistor in the OLED pixel circuit shifts is eliminated, so that the stability of the OLED pixel circuit is increased, and the nonuniformity of a display panel can be improved effectively. Further, the OLED is not in a positive bias state in a non-light-emitting stage (i.e., the data storage and threshold compensation stage), and is in the positive bias state only in the light-emitting stage after the data voltages V_{DATA} of all pixel circuits are stored, which shortens a time period when the OLED is in a positive bias state, and thus a service life of the OLED can be extended effectively.

Further, as shown in FIG. 3, signals V_{DD} and Em are slightly advanced with respect to the scanning signal S1 for the first row of OLED pixel circuits in a frame period, but are slightly delayed with respect to the scanning signal Sn for the last row of OLED pixel circuits, so as to ensure the correctness of data writing.

In the OLED pixel circuit in the present embodiment, since the threshold voltage of the driving transistor in the OLED pixel circuit is compensated in advance by the storing capacitor, and the threshold voltage is superposed on a data signal in data writing, the technical effect of compensating a shift of the threshold voltage can be achieved. Meanwhile, since the OLED is no longer in a positive bias control state for a long time, a service life of the OLED can be extended effectively.

### Embodiment 2

The present embodiment provides a display device, which includes a plurality of the OLED pixel circuit exemplified in Embodiment 1. An OLED display array is formed by arranging a plurality of the OLED pixel circuits shown in FIG. 2 in an matrix, and light emission of the OLED display array can be achieved by respectively controlling a plurality of pixel circuits, thereby achieving display.

The display device may be any product or component having a display function, such as an electronic paper, a mobile phone, a tablet computer, a television set, a display device, a laptop computer, a digital photo frame, a navigator, or the like.

The organic light-emitting diode display device according to the present embodiment employs the OLED pixel circuits exemplified in Embodiment 1. Since each of the OLED pixel circuits has a better stability, brightness uniformity of light emitted from the respective OLED pixel circuits is ensured, accordingly, the display quality of the display device is increased. Thus, the OLED display device herein has higher stability, lower cost, and is more suitable for mass production. Meanwhile, since a service life of the OLED is extended, a service life of the organic light-emitting diode display device can be extended effectively.

The OLED pixel circuit, which is driven in a manner of a voltage-written type active matrix organic light-emitting diode, according to the present invention is not affected by the threshold voltage V_{TH} of the driving transistor by employing the structure of 5T1C in combination with the control of the variable voltage supply terminal V_{DD} so as to store the data voltage V_{DATA} and compensate the threshold voltage V_{TH} of the driving transistor. That is, the OLED pixel circuit has a function of compensating a shift of the threshold voltage of the driving transistor therein, so that a drive current of an OLED is not affected by the threshold voltage of the driving transistor, and thus, the nonuniformity of an image displayed on the active matrix organic light-emitting diode display device is improved. Meanwhile, since an OLED in the OLED pixel circuit is not in a positive bias state in the data storage and threshold compensation stage, a service life of the OLED can be extended effectively, and thus, a service life of the OLED display device can be extended effectively. Further, the OLED pixel circuit, due to its simple structure, has high reliability and maintains advantages of an existing OLED pixel circuit such as high precision grayscale control and high stability, which make the organic light-emitting diode display device including the OLED pixel circuit have better brightness uniformity, lower cost, and more suitable for mass production.

It should be understood that, the above embodiments are only exemplary embodiments for the purpose of explaining the principle of the present invention, and the present invention is not limited thereto. For a person skill in the art, various improvements and modifications may be made without departing from the spirit and essence of the present invention. These improvements and modifications also fall within the protection scope of the present invention.

1-12. (canceled)

13. An OLED pixel circuit, including a data storage and threshold compensation module, a switch module, a driving module, and a light-emitting module, wherein
the data storage and threshold compensation module is connected to the driving module, the switch module, a scanning signal line, and a data signal line, respectively, and is used for inputting a data signal on the data signal line to the driving module and compensating a threshold voltage of the driving module according to a scanning signal of the scanning signal line; and
the switch module is connected to the driving module, the light-emitting module, and a light emission control signal line, respectively, and is used for inputting a data signal provided by the threshold-compensated driving module to the light-emitting module according to a control signal of the light emission control signal line, so as to drive the light-emitting module to emit light.

14. The OLED pixel circuit according to claim 13, wherein the driving module includes a control terminal, an input terminal, and an output terminal, wherein
the control terminal of the driving module is connected to the data storage and threshold compensation module, the input terminal of the driving module is connected to the switch module and a first voltage terminal, which is a variable voltage supply terminal, and the output terminal of the driving module is connected to the data storage and threshold compensation module and the switch module.

15. The OLED pixel circuit according to claim 14, wherein, the light-emitting module is further connected to a second voltage terminal, which is a low voltage supply terminal.

16. The OLED pixel circuit according to claim 15, wherein, the driving module includes a first transistor, the control terminal of the driving module is a gate of the first transistor, the input terminal of the driving module is a first electrode of the first transistor, and the output terminal of the driving module is a second electrode of the first transistor.

17. The OLED pixel circuit according to claim 16, wherein, the data storage and threshold compensation module includes a second transistor, a third transistor, and a storing capacitor, wherein
a gate of the third transistor is connected to the scanning signal line, a first electrode of the third transistor is connected to the data signal line, and a second electrode of the third transistor is connected to one terminal of the storing capacitor; and
a gate of the second transistor is connected to the scanning signal line, a first electrode of the second transistor is connected to the gate of the first transistor and the other terminal of the storing capacitor, and a second electrode of the second transistor is connected to the second electrode of the first transistor.

18. The OLED pixel circuit according to claim 17, wherein, the switch module includes a fourth transistor and a fifth transistor, wherein
a gate of the fourth transistor is connected to the light emission control signal line, a first electrode of the fourth transistor is connected to the first electrode of the first transistor, and a second electrode of the fourth transistor is connected to the second electrode of the third transistor and the one terminal of the storing capacitor; and
a gate of the fifth transistor is connected to the light emission control signal line, a first electrode of the fifth transistor is connected to the second electrode of the first transistor, and a second electrode of the fifth transistor is connected to the light-emitting module.

19. The OLED pixel circuit according to claim 18, wherein, the first to fifth transistors in the OLED pixel circuit are all N-type transistors, all P-type transistors, or a collection of N-type transistors and P-type transistors.

20. The OLED pixel circuit according to claim 19, wherein, the light-emitting module includes an OLED, an anode of the OLED is connected to the second electrode of the fifth transistor, and a cathode of the OLED is connected to the second voltage terminal.

21. A display device, including an OLED pixel circuit, the OLED pixel circuit including a data storage and threshold compensation module, a switch module, a driving module, and a light-emitting module, wherein
the data storage and threshold compensation module is connected to the driving module, the switch module, a scanning signal line, and a data signal line, respectively, and is used for inputting a data signal on the data signal line to the driving module and compensating a threshold voltage of the driving module according to a scanning signal of the scanning signal line; and
the switch module is connected to the driving module, the light-emitting module, and a light emission control signal line, respectively, and is used for inputting a data signal provided by the threshold-compensated driving module to the light-emitting module according to a control signal of the light emission control signal line, so as to drive the light-emitting module to emit light.

22. The display device according to claim 21, wherein the driving module includes a control terminal, an input terminal, and an output terminal, wherein
the control terminal of the driving module is connected to the data storage and threshold compensation module, the input terminal of the driving module is connected to the switch module and a first voltage terminal, which is a variable voltage supply terminal, and the output terminal of the driving module is connected to the data storage and threshold compensation module and the switch module.

23. The display device according to claim 22, wherein, the light-emitting module is further connected to a second voltage terminal, which is a low voltage supply terminal.

24. The display device according to claim 23, wherein, the driving module includes a first transistor, the control terminal of the driving module is a gate of the first transistor, the input terminal of the driving module is a first electrode of the first transistor, and the output terminal of the driving module is a second electrode of the first transistor.

25. The display device according to claim 24, wherein, the data storage and threshold compensation module includes a second transistor, a third transistor, and a storing capacitor, wherein
a gate of the third transistor is connected to the scanning signal line, a first electrode of the third transistor is connected to the data signal line, and a second electrode of the third transistor is connected to one terminal of the storing capacitor; and
a gate of the second transistor is connected to the scanning signal line, a first electrode of the second transistor is connected to the gate of the first transistor and the other terminal of the storing capacitor, and a second electrode of the second transistor is connected to the second electrode of the first transistor.

26. The display device according to claim 25, wherein, the switch module includes a fourth transistor and a fifth transistor, wherein
a gate of the fourth transistor is connected to the light emission control signal line, a first electrode of the fourth transistor is connected to the first electrode of the first transistor, and a second electrode of the fourth transistor is connected to the second electrode of the third transistor and the one terminal of the storing capacitor; and
a gate of the fifth transistor is connected to the light emission control signal line, a first electrode of the fifth transistor is connected to the second electrode of the first transistor, and a second electrode of the fifth transistor is connected to the light-emitting module.

27. The display device according to claim 26, wherein, the first to fifth transistors in the OLED pixel circuit are all N-type transistors, all P-type transistors, or a collection of N-type transistors and P-type transistors.

28. The display device according to claim 27, wherein, the light-emitting module includes an OLED, an anode of the OLED is connected to the second electrode of the fifth transistor, and a cathode of the OLED is connected to the second voltage terminal.

29. A driving method of an OLED pixel circuit, wherein the OLED pixel circuit is the OLED pixel circuit according to claim 8, and the driving method includes steps of:
in a data storage and threshold compensation stage, inputting a scanning signal and a data signal, so that the data storage and threshold compensation module is turned on, and the data storage and threshold compensation module stores a data voltage and compensates a threshold voltage of the driving module; and
in a light-emitting stage, inputting a light emission control signal, so that the switch module is turned on, and the driving module drives the light-emitting module to emit light.

30. The driving method according to claim 29, wherein, the driving method specifically includes steps of:
in the data storage and threshold compensation stage, inputting the scanning signal through the scanning signal line, and inputting the data signal through the data signal line, so that a low level of the first voltage terminal is input to the first electrode of the first transistor, the second and third transistors are turned on, the fourth and fifth transistors are turned off, and the storing capacitor stores the data voltage and a threshold voltage of the first transistor; and
in the light-emitting stage, inputting the light emission control signal through the light emission control signal line, so that the second and third transistors are turned off, the fourth and fifth transistors are turned on, a high level of the first voltage terminal is input to the first electrode of the first transistor, and the second electrode of the first transistor drives the light-emitting module to emit light, so as to achieve display.

31. The driving method according to claim 30, wherein, the low level of the first voltage terminal ranges from 1 V to 3 V, and the high level of the first voltage terminal ranges from 10 V to 15 V.
